(19) United States
(12) Patent Application Publication
(10) Pub. No.: US 2002/0012218 A1
(43) Pub. Date: Jan. 31, 2002

(54) Grounding device

(75) Inventors: Chun-Liang Li, Tainan City (TW); Ching-Yao Li, Yung-Kang City (TW)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Compucase Enterprise Co., Ltd.

(21) Appl. No.: 09/853,979

(22) Filed: May 11, 2001

(30) Foreign Application Priority Data
Jul. 27, 2000 (TW) 089212991

(51) Int. Cl. H05F 3/00

(52) U.S. Cl. 361/221; 361/733; 361/753

(57) ABSTRACT

A grounding device includes flexible, insulative left and right sliding bodies and a conductive strip. Each sliding body has inner and outer abutment walls, and includes an urging tongue portion which has a distal end flush with the inner abutment wall when the latter abuts against an outer wall of an electric component module accommodated within a housing. The conductive strip has a contact end portion anchored on the urging tongue portion and clamped between the module and the urging tongue portion, a middle portion extending from the contact end portion into a mounting slot formed in a respective one of the sliding bodies, and a contact juncture protruding beyond the outer abutment wall to abut against an inner wall of the housing to thereby establish electrical contact between the module and the housing.

### BACKGROUND OF THE INVENTION

1. Field of the Invention

The present invention relates to a grounding device, more particularly to a grounding device which is disposed between a housing of an electronic device and an electric component module removably mounted in the housing so as to drain static charges that accumulates on the electric component module.

2. Description of the Related Art

Memory devices, such as disk drives, are generally mounted fixedly within a computer housing. In view of the demand to process huge amounts of data, removable memory devices have been developed to allow users to store data and programs in various memory devices.

With reference to FIGS. 1 and 2, an electric component module 2, such as a memory device, is removably and slidably mounted in guideways 12 defined by upper and lower guide plates 11 of a housing 1, which is formed from metal. To drain static charges on the module 2 and to facilitate sliding movement of the module 2, a grounding device 3 is disposed between the housing 1 and the module 2. The grounding device 3 includes left and right sliding bodies 31 and a plurality of electrically conductive studs 32. Each of the conductive studs 32 has a tail portion 321 and a head portion 322. The sliding bodies 31 are mounted outboard to the module 2 by means of the conductive studs 32 which are extended through the sliding bodies 31, with the tail portions 321 thereof inserted into mounting holes 21 formed in lateral walls of the module 2, while the head portions 322 project beyond the sliding bodies 31 to contact inner side walls of the housing 1, thereby establishing electrical contact between the module 2 and the housing 1 so as to drain the static charges on the module 2 via the housing 1.

However, the conventional grounding device 3 is defective in terms of assembly. As the sliding bodies 31 are mounted in the lateral walls of the module 2 by means of the tail portions 321 of the conductive studs 32 without any securing or locking means, the sliding bodies 3 may easily detach from the module 2 during outward pulling of the module 2 from the housing 1. Moreover, as grounding is achieved mainly via the head portions 322 of the conductive studs 32 which contact the inner side walls of the housing 1, the grounding effect is not satisfactory.

### SUMMARY OF THE INVENTION

Therefore, the main object of the present invention is to provide a grounding device which is disposed between a housing of an electronic device and an electric component module removably mounted in the housing so as to drain static charges that accumulate on the electric component module.

Accordingly, a grounding device of this invention is adapted for draining static charges that accumulate on an electric component module in an electrically conductive housing. The housing includes left and right side walls spaced apart from each other in a longitudinal direction, and at least two guideways disposed on and inboard to the left and right side walls respectively and extending in a first direction transverse to the longitudinal direction. The electric component module is accommodated in the housing, and includes a front panel with left and right lateral edges opposite to each other in the longitudinal direction, and electrically conductive left and right lateral walls respectively extending rearwardly from the left and right lateral edges in the first direction and facing toward the left and right side walls. Each of the guideways includes upper and lower guiding plates which are spaced apart from each other in a second direction transverse to both the first direction and the longitudinal direction. The upper and lower guiding plates of the guideways are formed by punching the left and right side walls. The grounding device includes electrically insulative left and right sliding bodies, and an electrically conductive strip. The left and right sliding bodies are formed from a flexible material and are adapted to be detachably secured to the left and right lateral walls, respectively. Each of the left and right sliding bodies includes upper and lower sliding wall surfaces, inner and outer abutment walls, and an urging tongue portion. The upper and lower sliding wall surfaces are opposite to each other in the second direction and are adapted to abut against the upper and lower guiding plates of a respective one of the guideways. The inner and outer abutment walls are spaced apart from each other in the longitudinal direction. The inner abutment wall has first and second inner abutment surfaces opposite to each other in the longitudinal direction. The first inner abutment surface is adapted to abut against a respective one of the left and right lateral walls. The outer abutment wall has first and second outer abutment surfaces opposite to each other in the longitudinal direction. The first outer abutment surface faces toward the second inner abutment surface. The second outer abutment surface is adapted to face toward the respective one of the left and right side walls. The outer abutment wall includes an inner peripheral portion which defines a mounting slot extending from the second outer abutment surface in the longitudinal direction to communicate with the second inner abutment surface. The urging tongue portion has proximate and distal ends. The proximate end is integrally formed with the second inner abutment surface. The distal end extends in the first direction and toward a respective one of the left and right lateral walls so as to be disposed beyond the first inner abutment surface in the longitudinal direction such that the distal end is forced to be flush with the first inner abutment surface against biasing action of the urging tongue portion when the first inner abutment surface abuts against the respective one of the left and right lateral walls. The distal end has an urging abutment surface adapted to abut against the respective one of the left and right lateral walls. The conductive strip has a contact end portion, a middle portion, and a securing end portion. The contact end portion is anchored on the urging abutment surface so as to be clamped between a respective one of the left and right lateral walls and the urging abutment surface when the urging tongue portion is flush with the first inner abutment surface. The middle portion extends from the contact end portion into the mounting slot, and terminates at a contact juncture. The securing end portion extends from the contact juncture and is disposed to anchor on the inner peripheral portion such that the contact juncture is forced away from the respective one of the left and right lateral walls by the securing end portion and the middle portion, and protrudes in the longitudinal direction and beyond the second outer abutment surface so as to abut against a respective one of the left and right side walls, thereby establishing electrical contact between the respective one of the left and right lateral walls and the respective one of the left and right side walls.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional grounding device adapted to be disposed between an electric component module and a housing;

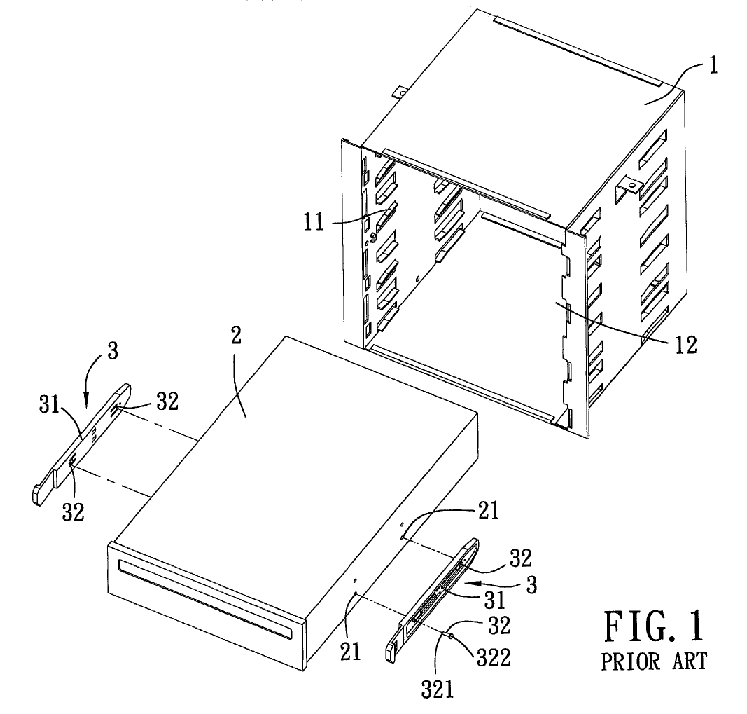

FIG. 2 is a fragmentary partly sectional top view showing the conventional grounding device mounted between the module and the housing;

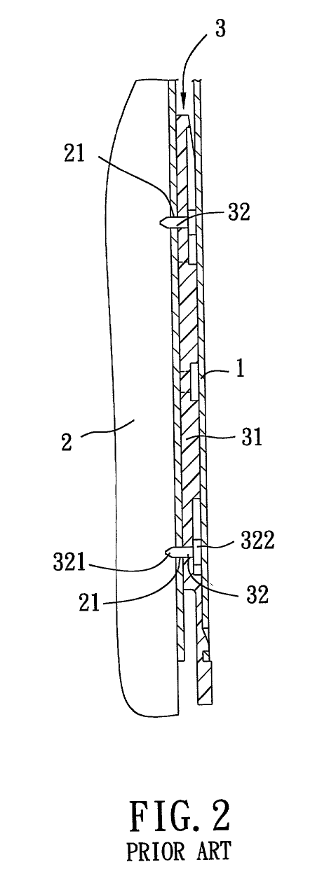

FIG. 3 is a perspective view illustrating how the preferred embodiment of a grounding device according to the present invention is mounted on an electric component module within a housing;

FIG. 4 is an exploded perspective view of the preferred embodiment in relation to the electric component module and the housing;

FIG. 5 is an exploded perspective view of the preferred embodiment; and

FIG. 6 is a fragmentary partly sectional top view illustrating how the preferred embodiment is mounted between the electric component module and the housing.

### DETAILED DESCRIPTION OF THE PREFERRED EMBODIMENT

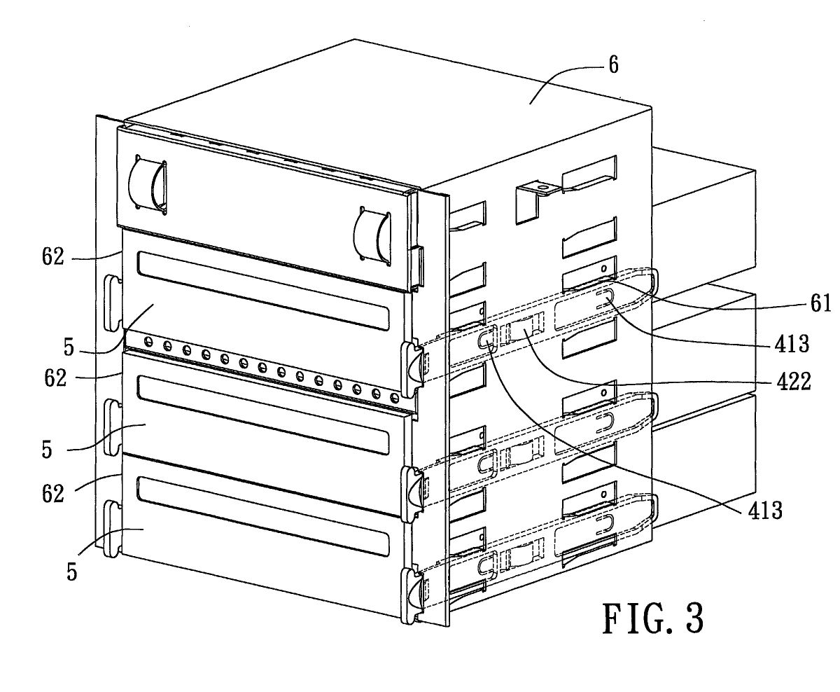

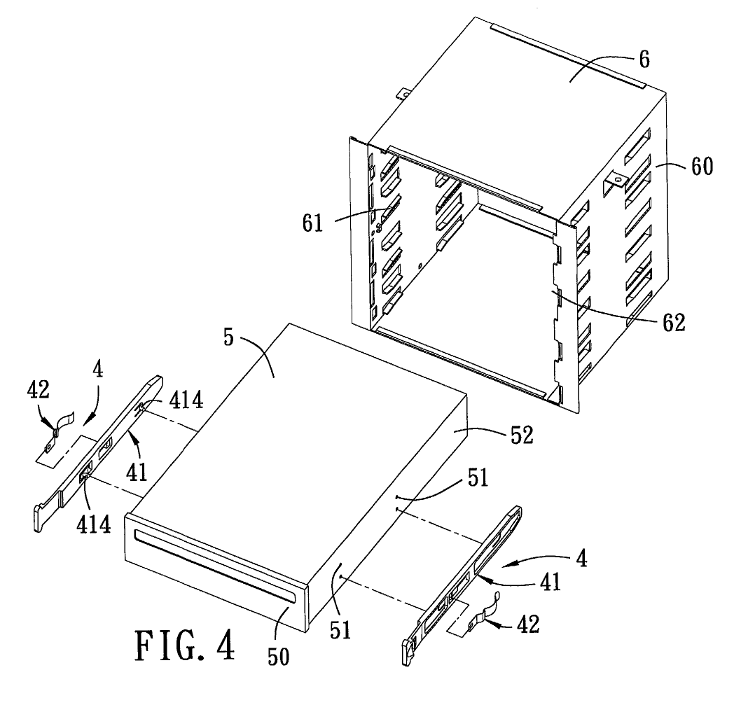

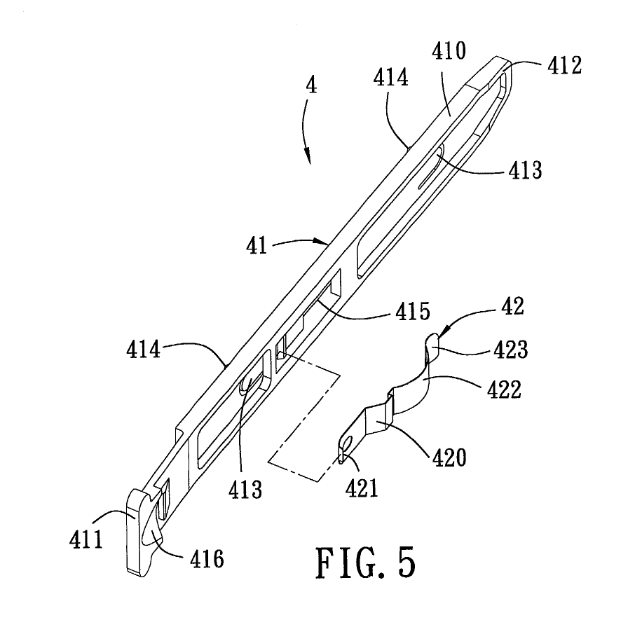

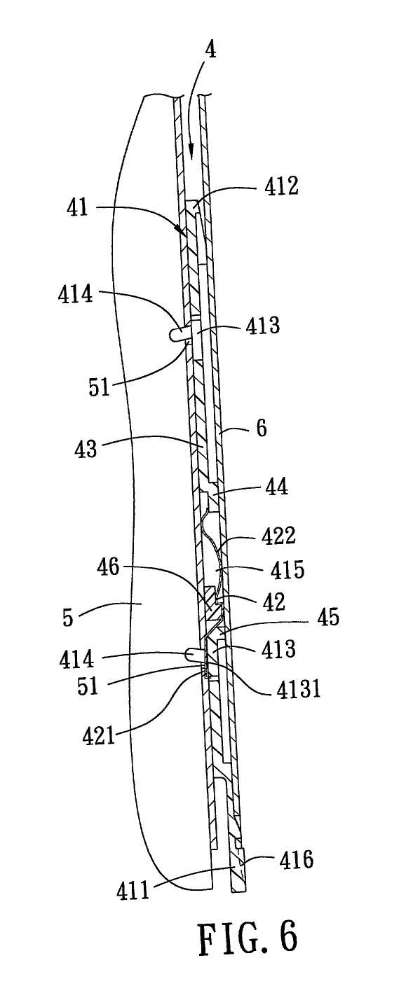

With reference to FIGS. 3 to 6, the preferred embodiment of a grounding device 4 according to the present invention is shown to be adapted for draining static charges that accumulate on an electric component module 5, via an electrically conductive housing 6 accommodated within a main body frame of an electronic device, such as a computer (not shown). The housing 6 is formed from metal, and includes left and right side walls 60 spaced apart from each other in a longitudinal direction, and at least two guideways 62 disposed on and inboard to the left and right side walls 60, respectively, and extending in a first direction transverse to the longitudinal direction. Each of the guideways 62 includes upper and lower guiding plates 61 which are spaced apart from each other in a second direction transverse to both the first direction and the longitudinal direction. The upper and lower guiding plates 61 are formed by punching the left and right side walls 60 inwardly. The electric component module 5 is removably accommodated in the housing 6, and includes a front panel 50 with left and right lateral edges opposite to each other in the longitudinal direction, and electrically conductive left and right lateral walls 52 respectively extending rearwardly from the left and right lateral edges in the first direction and facing toward the left and right side walls 60. Each of the left and right lateral walls 52 is formed with two mounting holes 51.

The grounding device 4 is shown to include electrically insulative left and right sliding bodies 41, and an electrically conductive strip 42. In this embodiment, the grounding device 4 includes two conductive strips 42.

The left and right sliding bodies 41 are formed from a flexible material and are adapted to be detachably secured to the left and right lateral walls 52, respectively. Each of the left and right sliding bodies 41 is an elongated block having front and rear end portions 411, 412 opposite to each other in the first transverse direction. The front end portion 411 is adapted to extend forwardly of the front panel 50, and includes a recessed press portion 416 adapted to facilitate pulling of the electric component module 5 from the housing 6. Each of the left and right sliding bodies 41 includes upper and lower sliding wall surfaces 410, inner and outer abutment walls 43, 44, and a first urging tongue portion 413.

The upper and lower sliding wall surfaces 410 are opposite to each other in the second direction and are adapted to abut against the upper and lower guiding plates 61 of a respective one of the guideways 62.

The inner and outer abutment walls 43, 44 are spaced apart from each other in the longitudinal direction. The inner abutment wall 43 has first and second inner abutment surfaces opposite to each other in the longitudinal direction. The first inner abutment surface is adapted to abut against a respective one of the left and right lateral walls 52. The outer abutment wall 44 has first and second outer abutment surfaces opposite to each other in the longitudinal direction. The first outer abutment surface faces toward the second inner abutment surface. The second outer abutment surface is adapted to face toward the respective one of the left and right side walls 60. The outer abutment wall 44 includes an inner peripheral portion which defines a mounting slot 415 that extends from the second outer abutment surface in the longitudinal direction to communicate with the second inner abutment surface. The second inner abutment surface and the first outer abutment surface cooperatively confine an accommodation space therebetween.

The first urging tongue portion 413 is disposed proximate to the front end portion 411, and has a proximate end integrally formed with the second inner abutment surface, and a distal end extending in the first direction and toward a respective one of the left and right lateral walls 52 so as to be disposed beyond the first inner abutment surface in the longitudinal direction. The distal end has an urging abutment surface 4131 adapted to abut against the respective one of the left and right lateral walls 52. When a respective one of the left and right sliding bodies 41 is mounted outboard to a respective one of the left and right lateral walls 52, the first inner abutment surface abuts against the respective one of the left and right lateral walls 52, and the distal end is forced to be flush with the first inner abutment surface against biasing action of the first urging tongue portion 413. In addition, the distal end is disposed to extend toward the front end portion 411, and has an inner lateral surface which is opposite to the urging abutment surface 4131 in the longitudinal direction and which is communicated with the accommodation space. The first urging tongue portion 413 is molded from the inner abutment wall 43 such that the distal end is depressible to permit the inner lateral surface to extend into the accommodation space. The distal end further includes a first anchored stud 414. The first anchored stud 414 is disposed to extend uprightly from the urging abutment surface 4131 and is adapted to be received in the mounting hole 51 in the respective one of the left and right lateral walls 52. In this embodiment, each of the left and right sliding bodies 41 further includes a second urging tongue portion 413 that is proximate to the rear end portion 412 thereof, and that has a distal end provided with a second anchored stud 414 adapted to be received in the respective one of the left and right lateral walls 52. The first and second urging tongue portions 413 are slightly inclined toward each other such that the distance therebetween is shorter than that between the two mounting holes 51. As such, the left and right sliding bodies 41 can be better secured to the left and right lateral walls 52.

The conductive strip 42 is formed from metal, and has a contact end portion 421, a middle portion 420, and a securing end portion 423. The contact end portion 421 is anchored on the urging abutment surface 4131 by means of a hooking hole formed therein to engage the first anchored stud 414, and is clamped between a respective one of the left and right lateral walls 52 and the urging abutment surface 4131 when the first urging tongue portion 413 is flush with the first inner abutment surface. Certainly, the contact end portion 421 may be anchored on any other suitable part of the respective sliding body 41. The middle portion 420 extends from the contact end portion 421 into the mounting slot 415 and terminates at a contact juncture 422. The securing end portion 423 extends from the contact juncture 422, and is disposed to anchor on the inner peripheral portion. The conductive strip 42 is configured so that the contact juncture 422 is forced away from the respective one of the left and right lateral walls 52 by both the securing end portion 423 and the middle portion 420, and protrudes in the longitudinal direction and beyond the second outer abutment surface so as to abut against a respective one of the left and right side walls 60. As such, electrical contact is established between the respective one of the left and right lateral walls 52 and the respective one of the left and right side walls 60 to permit draining of static charges on the electric component module 5 via the housing 6.

The grounding device 4 further includes a reinforcing member 45 disposed to extend in the longitudinal direction to interconnect the second inner abutment surface and the first outer abutment surface, and to be integrally formed with the inner peripheral portion to thereby permit the proximate end of the first urging tongue portion 413 to rest on the inner peripheral portion.

Furthermore, the first inner abutment surface includes a passage disposed proximate to the proximate end and distal to the distal end of the first urging tongue portion 413. The passage extends from the first inner abutment surface to the second inner abutment surface so as to communicate with the mounting slot 415, thereby permitting the middle portion 420 of the conductive strip 42 to pass therethrough. The inner abutment wall 43 includes a guiding block 46 disposed to extend from the second inner abutment surface toward the mounting slot 415 such that the middle portion 420 passes through the passage and is guided by the guiding block 46 to be directed toward the second inner abutment surface, thereby forcing the contact juncture 422 to protrude beyond the second outer abutment surface between the guiding block 46 and the securing end portion 423.

In use, the sliding bodies 41 together with the conductive strips 42 are respectively mounted outboard to the left and right lateral walls 52 of the electric component module 5, and the electric component module 5 together with the grounding device 4 is inserted into the housing 6 such that the contact junctures 422 respectively abut against the left and right side walls 60 of the housing 6. Static charges that accumulate on the electric component module 5 can be drained via the grounding device 4 and the housing 6 at this time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A grounding device for draining static charges that accumulate on an electric component module in an electrically conductive housing, the housing including left and right side walls spaced apart from each other in a longitudinal direction, and at least two guideways disposed on and inboard to the left and right side walls respectively and extending in a first direction transverse to the longitudinal direction, the electric component module being accommodated in the housing and including a front panel with left and right lateral edges opposite to each other in the longitudinal direction, and electrically conductive left and right lateral walls respectively extending rearwardly from the left and right lateral edges in the first direction and facing toward the left and right side walls, each of the guideways including upper and lower guiding plates which are spaced apart from each other in a second direction transverse to both the first direction and the longitudinal direction, the upper and lower guiding plates of the guideways being formed by punching the left and right side walls, said grounding device comprising:
electrically insulative left and right sliding bodies formed from a flexible material and adapted to be detachably secured to the left and right lateral walls respectively, each of said left and right sliding bodies including:
upper and lower sliding wall surfaces opposite to each other in the second direction and adapted to abut against the upper and lower guiding plates of a respective one of the guideways;
inner and outer abutment walls spaced apart from each other in the longitudinal direction, said inner abutment wall having first and second inner abutment surfaces opposite to each other in the longitudinal direction, said first inner abutment surface being adapted to abut against a respective one of the left and right lateral walls, said outer abutment wall having first and second outer abutment surfaces opposite to each other in the longitudinal direction, said first outer abutment surface facing toward said second inner abutment surface, said second outer abutment surface being adapted to face toward the respective one of the left and right side walls, said outer abutment wall including an inner peripheral portion which defines a mounting slot extending from said second outer abutment surface in the longitudinal direction to communicate with said second inner abutment surface; and
a first urging tongue portion having a proximate end integrally formed with said second inner abutment surface, and a distal end extending in the first direction and toward a respective one of the left and right lateral walls so as to be disposed beyond said first inner abutment surface in the longitudinal direction such that said distal end is forced to be flush with said first inner abutment surface against biasing action of said first urging tongue portion when said first inner abutment surface abuts against the respective one of the left and right lateral walls, said distal end having an urging abutment surface adapted to abut against the respective one of the left and right lateral walls; and
an electrically conductive strip having a contact end portion anchored on said urging abutment surface so as to be clamped between a respective one of the left and right lateral walls and said urging abutment surface when said first urging tongue portion is flush with said first inner abutment surface, a middle portion extending from said contact end portion into said mounting slot and terminating at a contact juncture, and a securing end portion extending from said contact juncture and disposed to anchor on said inner peripheral portion such that said contact juncture is forced away from the respective one of the left and right lateral walls by said securing end portion and said middle portion and protrudes in the longitudinal direction and beyond said second outer abutment surface so as to abut against a respective one of the left and right side walls, thereby establishing electrical contact between the respective one of the left and right lateral walls and the respective one of the left and right side walls.

2. The grounding device according to claim 1, wherein each of said left and right sliding bodies includes front and rear end portions opposite to each other in the first transverse direction, said second inner abutment surface and said first outer abutment surface confining an accommodation space therebetween, said distal end being disposed to extend toward said front end portion and having an inner lateral surface which is opposite to said urging abutment surface in the longitudinal direction and which is communicated with said accommodation space.

3. The grounding device according to claim 2, wherein said distal end is molded from said inner abutment wall, and is depressible to permit said inner lateral surface to extend into said accommodation space, said distal end further including a first anchored stud disposed to extend uprightly from said urging abutment surface and adapted to be received in the respective one of the left and right lateral walls, said contact end portion having a hooking hole to sleeve on said first anchored stud, said grounding device further comprising a reinforcing member disposed to extend in the longitudinal direction to interconnect said second inner abutment surface and said first outer abutment surface, and to be integrally formed with said inner peripheral portion to thereby rest said proximate end on said inner peripheral portion.

4. The grounding device according to claim 3, wherein said first inner abutment surface has a passage disposed proximate to said proximate end and distal to said distal end, said passage extending from said first inner abutment surface to said second inner abutment surface so as to communicate with said mounting slot, thereby permitting said middle portion to pass therethrough.

5. The grounding device according to claim 4, wherein said inner abutment wall includes a guiding block disposed to extend from said second inner abutment surface toward said mounting slot such that said middle portion passes through said passage and is guided by said guiding block to be directed toward said second inner abutment surface, thereby forcing said contact juncture to protrude beyond said second outer abutment surface between said guiding block and said securing end portion.

6. The grounding device according to claim 2, wherein said front end portion is adapted to extend forwardly of the front panel, said front end portion including a recessed press portion adapted to facilitate pulling of the electric component module from the housing.

7. The grounding device according to claim 3, wherein each of said left and right sliding bodies further includes a second urging tongue portion, said first and second urging tongue portions being proximate to said front and rear end portions respectively, said second urging tongue portion having a distal end provided with a second anchored stud adapted to be received in the respective one of the left and right lateral walls, said first and second anchored studs being slightly inclined toward each other.
